(19) United States
(12) Patent Application Publication
(10) Pub. No.: US 2026/0365492 A1
(43) Pub. Date: Nov. 19, 2026

(54) LOAD SUSPENSION DEVICE, LIFTING DEVICE AND METHOD FOR LIFTING AND/OR MOVING A LOAD

(71) Applicant: Ludwig System GmbH & Co. KG, Bad Reichenhall (DE)

(72) Inventors: Dimitri KLOSTER, Bad Reichenhall (DE); Daniel RUNGE, Marktschellenberg (DE); Peter RUF, Bad Reichenhall (DE)

(21) Appl. No.: 19/678,385

(22) Filed: May 15, 2026

(30) Foreign Application Priority Data
May 15, 2025 (DE) 102025118846.7

(51) Int. Cl. B66C 1/66

(52) U.S. Cl. CPC B66C 1/66

(57) ABSTRACT

Disclosed is a load suspension device, a lifting device, and a method for lifting/moving a load therewith. The load suspension device is configured for attaching to a carrying means and for suspending a load. The load suspension device includes a base body, a curved hook body and a safety lever. The load is suspendable from the hook body. The safety lever is pivotably connected to the base body. The hook body is adjustable relative to the base body between an unloaded position and a loaded position in dependence on a load application by the load. The safety lever is configured to perform a pivoting movement relative to the hook body for suspending the load to the hook body in the unloaded position. The safety lever is configured to be coupled to the hook body in the loaded position such that the pivoting movement relative to the hook body is blocked.

### CROSS-REFERENCE TO RELATED APPLICATIONS

This application claims priority to DE 10 2025 118 846.7 filed May 15, 2025, the contents of which are hereby incorporated by reference herein in their entireties for all purposes.

### TECHNICAL FIELD OF THE INVENTION

The invention relates to a load suspension device, preferably a crane hook, a lifting device, preferably a crane, comprising the load suspension device, and a method for lifting and/or moving a load, wherein the load suspension device is used.

### BACKGROUND OF THE INVENTION

In the field of lifting technology, for example in the construction industry and/or in timber construction and/or in the field of industrial applications and/or in the field of maritime applications and/or underwater applications and/or in the timber industry and/or in the field of logistics (e.g. in port logistics), load suspension devices (e.g. crane hooks) are used for lifting and/or moving loads. When lifting and/or moving loads, it is essential to prevent unintentional release of the load from the load suspension device to ensure operational safety. At the same time, it should be possible to suspend and detach loads with as little technical effort as possible. In technical terminology, the suspending of loads is also referred to as rigging and the detaching of loads as unrigging. For example, the term rigging can therefore refer to fastening the load to a crane (e.g. by suspending the load from the load suspension device fastened to a crane). The unrigging may refer to the release of the load from a crane (e.g. by detaching the load from the load suspension device).

In this context, WO 2009/065484 A1 discloses a device with a hook for suspending an object, comprising an articulated head with two cheeks. A pivot axis extends between the cheeks, about which the hook is pivotably articulated with a hub section between a closed position pivoted towards the joint head for suspending the object and a release position pivoted out of the joint head. Furthermore, a locking device with a locking bolt, which engages in a locking recess on the hook in the closed position, an actuator for unlocking the locking bolt, a receiver for a remote control for actuating the actuator and a power source for energizing the receiver and the actuator are provided. A safety lock comprising a locking piece is arranged on the joint head.

DE 10 2005 062 333 A1 describes a load hook with a hook attached to a hook tackle. A cover area is arranged at least partially between the hook tackle and the hook such that the hook is covered starting from the outer contour of the hook tackle. In the area of an opening of the hook, a hook mouth safety device is arranged which covers the opening. This hook mouth safety device is usually used to close the opening of the hook mouth. For this purpose, the safety catch can be pivoted from a closed position inwards into the opening of the hook mouth into an open position. Notches are provided on the inside of the tip facing the opening, into which the free end of the hook jaw safety device is inserted in the closed position.

Disadvantages of the solutions described in WO 2009/065484 A1 and DE 10 2005 062 333 A1 are that they are technically comparatively complex and that unintentional pivoting of the locking piece or the hook jaw safety catch, at least inwards, is not prevented. The load can therefore be released unintentionally (e.g. if the locking piece or the hook jaw safety catch is pushed open by unintentional contact with an object).

In particular in WO 2009/065484 A1 and DE 10 2005 062 333 A1 it is furthermore disadvantageous that the locking piece or the hook jaw safety device is pressed open by unintentional contact with an object and the object can unintentionally hook into the device of WO 2009/065484 A1 and into the load hook of DE 10 2005 062 333 A1.

### DESCRIPTION OF THE INVENTION

The invention is therefore based on the objective of providing an improved load suspension device which overcomes the disadvantages of known solutions. In particular, it is an objective of the invention to provide a solution with which the risk of unintentional release of the load from the load suspension device is reduced and/or eliminated. Furthermore, it is in particular an objective of the invention to provide a solution with which the risk of unintentional hooking of surrounding objects into the load suspension device is reduced and/or eliminated.

This objective is solved by a load suspension device, a lifting device and a method according to the invention, which are explained in more detail in the following description, with partial reference to the figures.

The load suspension device is configured for attaching to a carrying means and for suspending a load. The load suspension device comprises a base body, a curved hook body and a safety lever.

Optionally, the hook body is connected to the base body (preferably indirectly and/or via a displacement body). The load is suspendable from the hook body.

The safety lever is preferably a safety latch. The safety lever is pivotable (e.g. on the end side) connected to the base body (e.g. only). The hook body is adjustable (e.g. movable and/or pivotable and/or slidable and/or displaceable, etc.) relative to the base body between an unloaded position and a loaded position (and vice versa) in dependence on a load application by the load. The safety lever is configured to perform a pivoting movement relative to the hook body (e.g. to release a suspension opening) for suspending the load from the hook body in the unloaded position (e.g. about a pivot axis arranged on the base body). In other words, the safety lever can be pivoted away from the hook body and/or pivoted towards the hook body by the pivoting movement.

The safety lever is configured to be coupled (e.g. interlocked) with the hook body in the loaded position such that the pivoting movement relative to the hook body is blocked.

One advantage may be that unintentional release of the load from the load suspension device is prevented and/or the risk of unintentional release of the load from the load suspension device is reduced. If the load suspension device unintentionally comes into contact with surrounding objects when moving the load, the safety lever can be prevented from being pressed open by the objects and the hook body unintentionally becoming caught on the objects and/or the load unintentionally becoming detached.

In addition, it can be achieved that rigging and/or suspending the load from the load suspension device can be carried out conveniently and/or with little technical effort via the pivotable safety lever.

The term "adjustable" is intended to cover an unspecified movement of the hook body relative to the base body.

The hook body can be connected (e.g. indirectly) to the base body via the displacement body. The displacement body can be displaceable and/or movable relative to the base body in order to adjust the hook body relative to the base body between an unloaded position and a loaded position.

The base body may comprise an eyelet via which the load suspension device can be attached to a carrying means of a lifting device, such as a carrying rope of a crane.

It is conceivable that the safety lever is pressed against the hook body in the unloaded position (e.g. in a spring-loaded manner). For suspending the load from the hook body, the safety lever can be pressed inwards and/or pivoted into the receiving opening. After the suspending of the load, the safety lever can be pressed against the hook body again (e.g. in a spring-loaded manner), pivoting outwards. The hook body can then be adjusted relative to the base body from a load application by the load between an unloaded position and a loaded position, wherein the pivoting movement (e.g. inwards) of the safety lever is blocked by the coupling of the safety lever to the hook body.

The hook body and the safety lever can be brought into a coupled state and a non-coupled state according to the "latch and catch" principle.

In one embodiment example, the hook body may comprise at least one coupling recess. The safety lever may comprise (e.g. at its free end) at least one engagement section. The at least one engagement section may engage in the at least one coupling recess in the loaded position in order to connect the safety lever to the hook body in a form-fitting manner. For example, the at least one coupling recess can be open towards a direction opposite to the base body and/or towards the load.

The coupling recess can be undercut at least in sections.

This can advantageously represent a technically easy-to-implement and/or safe way of coupling the safety lever to the hook body.

In one embodiment example, the hook body may comprise at least one abutment surface which is arranged adjacent to the at least one coupling recess. The at least one engagement section may abut against the at least one abutment surface in the unloaded position. By an adjustment of the hook body from the unloaded position into the loaded position, the at least one engagement section may engage from the at least one abutment surface into the at least one coupling recess. It is conceivable that the at least one engagement section is pressed against the at least one abutment surface in the unloaded position (e.g. in a spring-loaded manner).

By providing the at least one abutment surface, an even more secure and/or guided engagement of the at least one engagement section into the at least one coupling recess can be achieved.

In one embodiment example, the hook body may comprise at least one insertion groove through which the at least one engagement section is guidable to the at least one coupling recess and/or to the at least one abutment surface.

The at least one insertion groove is preferably designed to be open towards the suspension opening. The safety lever can be guided from the suspension opening through the insertion groove to the at least one coupling recess. Preferably, the at least one insertion groove may comprise edge regions which are designed to guide the safety lever and/or the at least one engagement section.

This can simplify the coupling of the safety lever to the hook body.

In one embodiment example, the safety lever can comprise a T-shaped and/or undercut through recess through which a free end of the hook body is guidable.

The through recess can therefore form a material cut-out through which the free end of the hook body is guidable.

In principle, however, it is also conceivable that the free end of the hook body comprises a T-shaped and/or undercut through recess through which a free end of the safety lever is guidable.

In one embodiment example, the safety lever may comprise at least one projection at its free end, which forms the at least one engagement section. The at least one projection can be engaged in the at least one coupling recess in the loaded position.

Preferably, the at least one projection comprises two projections facing each other.

The at least one projection is preferably oriented parallel to a pivot axis of the safety lever about which the safety lever performs the pivoting movement.

In one embodiment example, the load suspension device may comprise a (e.g. electric) drive device by means of which the hook body is pivotable relative to the base body between the unloaded position and an open position (and vice versa). The drive device may, for example, comprise a servomotor.

The hook body can form at least in sections and/or limit at least in sections a suspension opening. The load can be suspendable from the hook body via the suspension opening. The suspension opening can be open in the open position and is closable in the unloaded position by means of the safety lever. It is conceivable, for example, that the safety lever is configured to close the suspension opening in the unloaded position of the hook body and to release it (e.g. inwards) by the pivoting movement.

The open position of the hook body is advantageously suitable, for example, for a visual inspection by a user, during which the load suspension device can be checked for damage or contamination, for example.

However, it is also conceivable, for example, that the open position is used in the course of an automated rigging process, e.g. by automatically and/or remotely pivoting the hook body from the open position to the unloaded position after positioning on a load and thereby engaging in a carrying means or rigging means of the load.

In one embodiment example, the drive device can be configured to pivot the hook body from the unloaded position into a release position (and vice versa). In the release position, the safety lever (e.g. the at least one engagement section) may be released from the hook body by sliding over the at least one abutment surface and through a lead-out groove of the hook body.

It is conceivable, for example, that the drive device pivots the hook body via the unloaded position into the release position. This allows the at least one engagement section to disengage from the coupling recess and be guided (e.g. spring-loaded) over the abutment surface through the lead-out groove.

As a result, the coupling between the safety lever and the hook body can be released automatically. This can be particularly, but not exclusively, advantageous in applications where the load suspension device is not accessible (e.g. underwater applications) and/or is only accessible at a safety risk (e.g. in construction and/or timber industry and/or certain industrial applications).

In one embodiment example, the load suspension device may comprise a worm gear drivingly connects the drive device and the hook body.

The worm gear can, for example, comprise an (optionally driving) worm shaft and a worm wheel meshing with the worm shaft. The worm wheel can be connected, preferably screwed, to the hook body.

As worm gears comprise a self-locking effect (also referred to as "self-locking" in technical jargon), it can be advantageous that the hook body is not pivotable due to the load application. The self-locking effect of the worm gear can counteract any pivoting of the hook body from the loaded position to the open position caused by the load application. This can further increase operational safety.

In one embodiment example, the load suspension device may comprise the displacement body to which the drive device is attached. The displacement body may be movable (e.g. pivotable and/or slidable) relative to the base body.

In addition, the load suspension device may comprise a spring device which is arranged to act between the displacement body and the base body. Preferably, the spring device acts on (e.g. presses) the displacement body towards the base body in the unloaded position such that the displacement body is arranged spaced-apart from the base body and/or an air gap is formed between the displacement body and the base body.

The spring device can, for example, comprise at least one compression spring. The compression spring can, for example, be compressed by the load application.

For example, a spring device can be compressed by the load application and press the unloaded displacement body and the hook body into the unloaded position.

During lifting, the spring device can be loaded by the load suspended from the hook body such that the hook body is moved from the unloaded position to the loaded position. In the unloaded position, an electrical power supply to the drive device can be enabled and in the loaded position, the electrical power supply to the drive device can be blocked in order to prevent the hook body from pivoting by means of the drive device under load application.

In one embodiment example, the load suspension device may comprise a sensor device by means of which it is detectable when the safety lever is in a first lever position in which the safety lever abuts against the hook body (e.g. with the at least one abutment surface).

Alternatively or additionally, by means of the sensor device it may be detectable when the safety lever is in a second lever position in which the safety lever is coupled to the hook body.

As an example, an angular range between the first lever position and the second lever position can be at most 2°, at most 3°, at most 4°, at most 5° or at most 10°.

Alternatively or additionally, by means of the sensor device it may be detectable when the safety lever is in a third lever position, in which the safety lever is pivoted away from the hook body, which is in the unloaded position.

Alternatively or additionally, by means of the sensor device it may be detectable when the safety lever is in a fourth lever position, in which the safety lever is pivoted away from the hook body in the open position.

The sensor device for detecting the first and/or second and/or third and/or fourth lever position may comprise, for example, a potentiometer.

In one embodiment example, the load suspension device may comprise a control device configured to block a pivoting of the hook body from the open position into the unloaded position by means of the drive device when it is detected by means of the sensor device that the safety lever is not in the fourth lever position.

In other words, the control device can be configured to block a closing of the hook body from the open position to the unloaded position by means of the drive device when it is detected that the safety lever is in the first lever position or the second lever position or the third lever position.

This can advantageously prevent the hook body from pivoting, thereby reducing the risk of unintentional opening of the hook body and/or the load suspension device under load.

In one embodiment example, the at least one coupling recess can comprise two coupling recesses that are arranged on opposite longitudinal outer sides of the hook body. The longitudinal outer sides may, for example, lie in planes that are oriented transversely and/or normal to a pivot axis of the safety lever.

In addition, the at least one engagement section can comprise two engagement sections which, in the loaded position, engage in the two coupling recesses in order to connect the safety lever to the hook body in a form-fitting manner.

This can advantageously result, for example, in the hook body and/or the safety lever being symmetrically loaded upon load application, which can further increase the load capacity and thus the operational safety.

In one embodiment example, the safety lever can be coupled to the hook body in the loaded position of the hook body such that a force caused by the load application can be at least partially conducted and/or transmitted from the hook body via the safety lever into the base body. In other words, the safety lever coupled to the hook body in the loaded position can enable a force flux from the hook body via the safety lever into the base body. This can advantageously increase the load capacity and operational safety of the load suspension device.

Alternatively or additionally, the hook body can be configured to release the safety lever upon an adjustment from the loaded position to the unloaded position by disengaging it from the at least one coupling recess.

Alternatively or additionally, the at least one coupling recess can be arranged at a free end and/or at least one longitudinal outer side of the hook body.

Alternatively or additionally, the pivoting movement of the safety lever in the unloaded position of the hook body can be blocked by the at least one abutment surface in a first pivoting direction (e.g. outwards) and enabled in an opposite second pivoting direction (e.g. inwards and/or into the receiving opening).

Alternatively or additionally, the safety lever can engage in the at least one coupling recess in the loaded position for coupling and not engage in the at least one coupling recess in the unloaded position for release.

Alternatively or additionally, the at least one further sensor device may be configured to detect when the hook body is in the loaded position. Alternatively or additionally, the load suspension device may comprise at least one further sensor device by means of which it is possible to detect when the hook body is in the unloaded position. Preferably, the at least one further sensor device comprises at least one light barrier or any other sensor suitable for this purpose.

It is conceivable that an electrical power supply is interrupted when it is detected by means of the at least one further sensor device that the hook body is in the loaded position. The load suspension device can be checked for load using the at least one further sensor device (e.g. the light barrier). When the light barrier is interrupted, for example, the electrical power supply to the drive device (e.g. to the motor) is interrupted.

Alternatively or additionally, the at least one further sensor device can be configured to detect when the hook body is in the open position. Alternatively or additionally, the at least one further sensor device may be configured to detect when the hook body is in the release position. Preferably, the at least one sensor device comprises at least one Hall effect sensor or any other sensor suitable for this purpose. For example, it is conceivable that the at least one further sensor device is configured to detect when the hook body is in the open position and to send a signal to a control device which controls the drive device such that pivoting of the hook body is ended. The at least one further sensor device can implement a limit switch-off of a travel path of the hook body.

Alternatively or additionally, the load suspension device can comprise a status output unit (e.g. an LED light). The status output unit can be controlled by means of a control device. The control device can be configured to control the status output unit such that the status output unit outputs a first signal (e.g. white light) when the sensor device detects that the safety lever is in the fourth lever position and optionally the further sensor device detects that the hook body is in the open position.

The control device can be configured to control the status output unit such that the status output unit outputs a second signal (e.g. green light) when the sensor device detects that the safety lever is in the first lever position and optionally the further sensor device detects that the hook body is in the unloaded position.

The control device can be configured to control the status output unit such that the status output unit outputs a third signal (e.g. blue light) when the sensor device detects that the safety lever is in the second lever position and optionally the further sensor device detects that the hook body is in the loaded position.

The control device can be configured to control the status output unit such that the status output unit outputs a fourth signal (e.g. yellow light) when the sensor device detects that the safety lever is in the third lever position and optionally the further sensor device detects that the hook body is in the unloaded position.

The control device can be configured to control the status output unit such that the status output unit outputs a fifth signal (e.g. red light) when the sensor device detects that the safety lever is in the third lever position and optionally the further sensor device detects that the hook body is in the loaded position.

The status output unit can be arranged on an outer shell of the load suspension device.

The status output unit can thus advantageously serve for optical communication of the status which the load suspension device is in.

Alternatively or additionally, the load suspension device may comprise a control device and a receiver unit, wherein the receiver unit is configured for wireless communication with a transmitter unit (e.g. a remote control) and the control device is configured to control the drive device in response to communication signals from the transmitter unit and/or in response to manual actuation of a button (e.g. a pushbutton) of the load suspension device.

For example, it is conceivable that the hook body is pivotable between the open position, the unloaded position and the release position by means of the remote control in such a way. In particular, it is conceivable that the hook body can be automatically released (e.g. by automatically moving the hook body from the unloaded position to the open position). This can have an advantageous effect on operational safety, as a person responsible for the unrigging can carry out the unrigging remotely rather than manually, which can reduce the risk of accidents.

According to a second general aspect, a lifting device (e.g. a crane) is provided. The lifting device comprises a carrying means (e.g. a carrying rope) and a load suspension device as disclosed herein. The load suspension device is attached to the carrying means.

In addition, the lifting device may optionally comprise the transmitting unit (e.g., a remote control) as disclosed herein.

A third general aspect relates to a method of lifting and/or moving a load, wherein the load suspension device is used as disclosed herein.

For example, the method may comprise providing a load (e.g., an object attached to a carrying rope) and a lifting device having a carrying means and the load suspension device fastened to the carrying means.

In addition, the method may comprise a suspending of the load side carrying means (e.g. via the suspension opening) from the hook body.

Furthermore, the method may comprise a load application to the hook body by lifting the load, whereby the hook body is adjusted to the loaded position and the safety lever is coupled to the hook body.

### BRIEF DESCRIPTION OF THE DRAWINGS

The preferred embodiments and features of the invention described above can be combined with each other as desired. Further details and advantages of the invention are described below with reference to the accompanying drawings. It shows:

FIG. 1 a schematic view of a load suspension device in one embodiment example (side view; hook body in unloaded position; safety lever abuts against abutment surface);

FIG. 2 a schematic view of the load suspension device of FIG. 1 (side view; hook body in loaded position; safety lever coupled to hook body);

FIG. 3 a schematic view of the load suspension device of FIG. 1 (side view; hook body in unloaded position; safety lever pivoted inwards);

FIG. 4 a schematic view of the load suspension device of FIG. 1 (side view; hook body in release position; safety lever pivoted outwards);

FIG. 5 a schematic view of the load suspension device of FIG. 1 (side view; hook body in open position; safety lever pivoted outwards);

FIG. 6 a schematic view of the load suspension device of FIG. 1 (side view; hook body between open position and unloaded position);

FIG. 7 a schematic view of a lifting device according to an embodiment example;

FIG. 8 a schematic and sectional view of a safety lever according to an embodiment example; and

FIG. 9 a schematic flow chart of a method according to an embodiment example.

### DETAILED DESCRIPTION

Identical or functionally equivalent units or elements are marked with the same reference signs in the figures. For their explanation, reference is also made in part to the description of other embodiment examples and/or figures in order to avoid repetition.

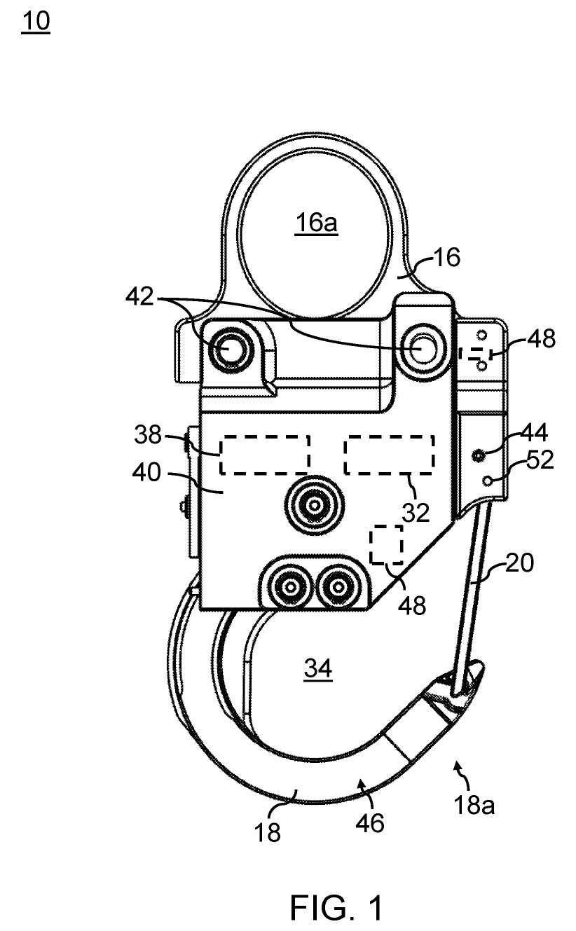

FIG. 1 shows a schematic view of a load suspension device 10 for attaching to a carrying means 12 and for suspending a load 14 according to an embodiment example.

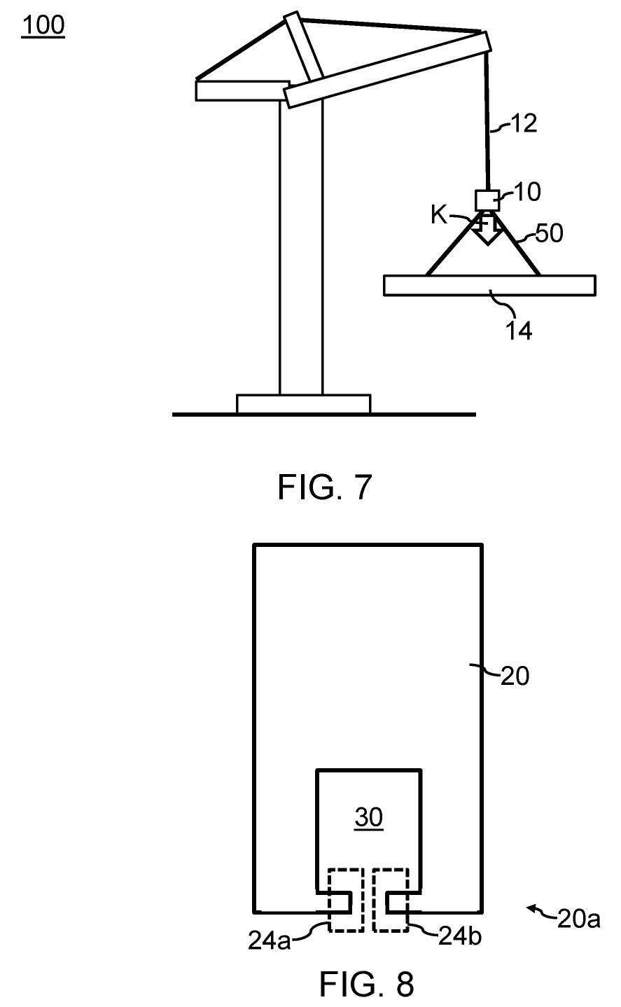

The load suspension device 10 comprises a base body 16 with an eyelet 16a, via which the load suspension device 10 can be attached to a carrying means 12 of a lifting device 100 (e.g. a carrying rope of a crane) (see also, for example, FIG. 7).

One end of a safety lever 20 is pivotably attached to the base body 16 (e.g. via a pivot joint). The safety lever 20 can thus be functionally designed as a safety latch.

The load suspension device 10 further comprises a (basically optional) displacement body 40. The displacement body 40 is movable relative to the base body 16 (e.g. rotatable, tiltable, slidable, etc.).

A curved, hook-shaped hook body 18 of the load suspension device 10 is movably supported on the displacement body 40 (e.g. telescopically supported so as to be extendable from a housing surrounding the displacement body 40). The hook body 18 is adjustable relative to the base body 16 (e.g. via a displacement of the displacement body) between an unloaded position and a loaded position in dependence on a load application by a load 14 attached to the hook body 18, e.g. by moving, tilting, pivoting and/or displacing the hook body 18 relative to the base body 16, etc.. The load application is symbolized in the figures by an arrow K.

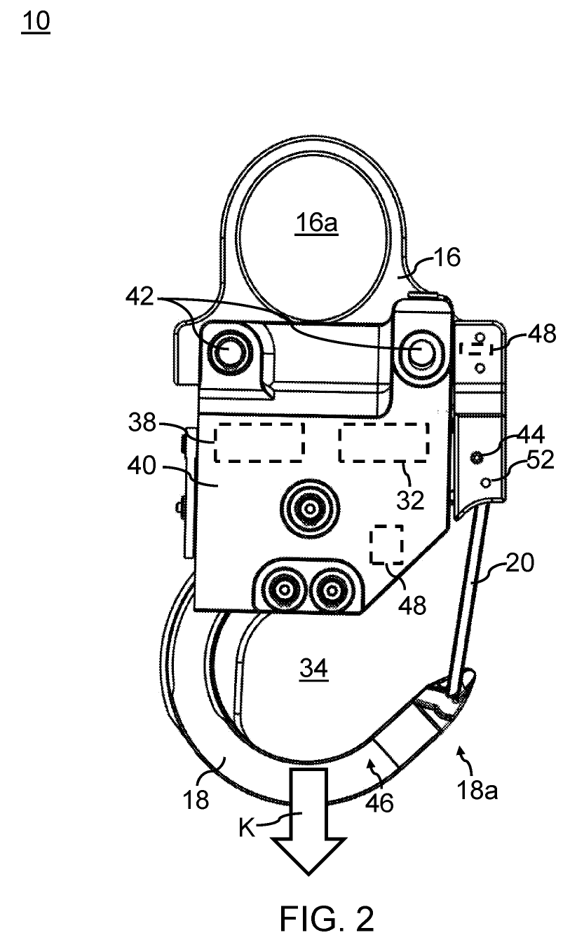

In this embodiment example, the load application K guides the hook body 18 supported on the displacement body 40 from the unloaded position (see FIG. 1) to the loaded position (see FIG. 2).

In the unloaded position of the hook body 18, the safety lever 20 abuts against at least one abutment surface 26 of the hook body 18. It is conceivable, for example, that the safety lever 20 is pressed against the abutment surface 26 by a spring 52 (e.g. acting on a pivot axis of the safety lever 20). For example, the spring 52 is a torsion spring acting between the safety lever 20 and the base body 16.

Preferably, the hook body 18 comprises two abutment surfaces 26 arranged on opposite longitudinal outer sides 46 of the hook body 18.

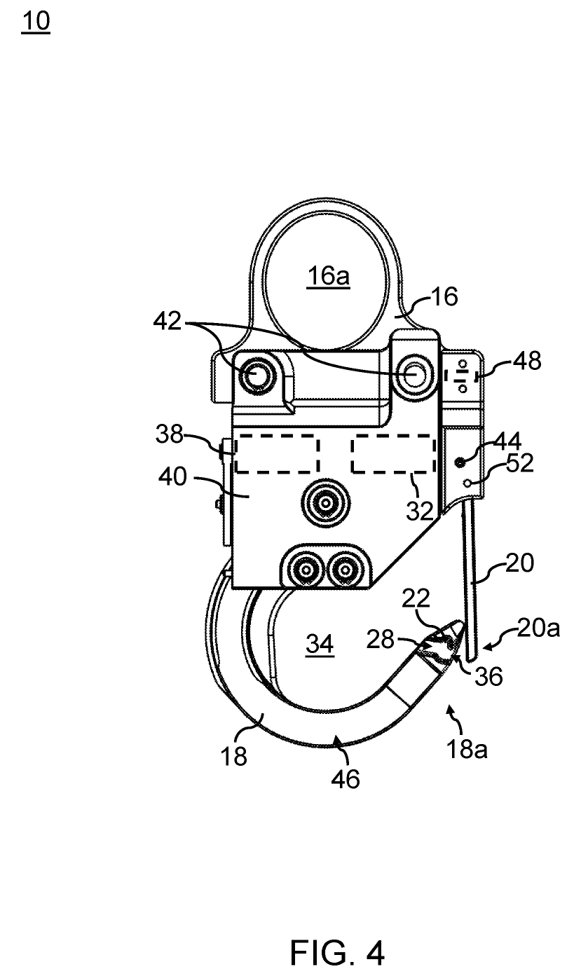

For suspending the load 14 or a load-side carrying means 50 (e.g. a load rope) connected to the load 14 from the hook body 18, the safety lever 20 is configured to perform a pivoting movement relative to the hook body 18 in the unloaded position in order to release a suspension opening 34. In the unloaded position of the hook body 18, the safety lever 20 is pivotable through an insertion groove 28 (see FIG. 4) away from the hook body 18 inwards into the suspension opening 34. Such, the safety lever 20 can perform a pivoting movement relative to the hook body 18.

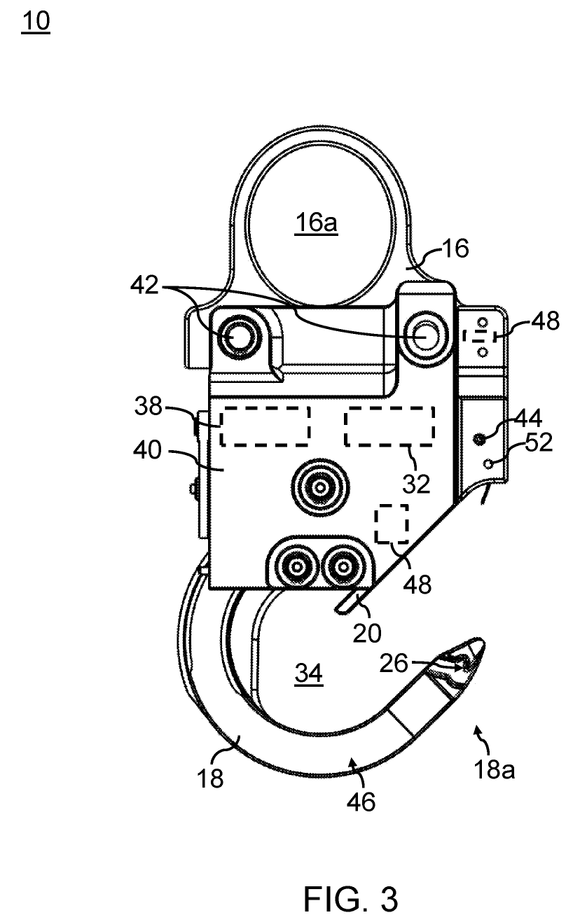

The inwardly pivoted position of the safety lever 20 is illustrated by way of example in FIG. 3.

This releases the suspension opening 34 of the load suspension device 10 to allow suspending of the load 14 or the load-side carrying means 50.

After the load 14 or the load-side carrying means 50 has been moved into the suspension opening 34, the safety lever 20 in this embodiment example returns to the position at the abutment surface 26 due to the action of the spring 52 on the safety lever 20 (see FIG. 1).

A subsequent lifting of the load 14 by means of the lifting device 100 results in that the hook body 18 is moved from the unloaded position (FIG. 1) to the loaded position (FIG. 2).

In order to prevent the pivoting movement of the safety lever 20 during lifting and movement of the load 14, and thus unintentional opening of the load suspension device 10, the safety lever 20 is configured to be coupled to the hook body 18 in the loaded position such that the pivoting movement relative to the hook body 18 is blocked. A pivoting of the safety lever 20 both inwards and outwards is thus blocked in the loaded position of the hook body 18.

For this purpose, the safety lever 20 can comprise at least one engagement section 24a-b which, in the loaded position, engages from the abutment surface 26 into the at least one coupling recess 22 by an adjusting of the hook body 18 from the unloaded position into the loaded position and engages in the at least one coupling recess 22 such to connect the safety lever 20 to the hook body 18 in a form-fitting manner.

Preferably, the hook body 18 comprises two coupling recesses 22 and the safety lever 20 comprises two engagement sections 24a-b, to which reference is made below by way of example.

The coupling recesses 22 are arranged on opposite longitudinal outer sides 46 of the hook body 18. Due to the perspective, only one of each of the two coupling recesses 22 and the longitudinal outer sides 46 is visible in the figures respectively.

The engagement sections 24a-b are each formed as projections facing each other (see also FIG. 8).

In the loaded position, the engagement sections 24a-b are engaged in the respective coupling recess 22 in order to connect the safety lever 20 to the hook body 18 in a form-fitting manner.

In the loaded position of the hook body 18, the safety lever 20 is coupled to the hook body 18 such that a force flux of a force caused by the load application is enabled from the hook body 18 via the safety lever 20 into the base body 16. At least part of the force caused by the load application can thus be conducted into the base body 16 via the safety lever 20.

In the loaded position of the hook body 18 shown as an example in FIG. 2, the pivoting movement of the safety lever 20 inwards, and thus unintentional opening of the load suspension device 10 during lifting and/or moving of the load 14, is thus blocked.

To release the safety lever 20 from the hook body 18, the hook body 18 is pivotable from the unloaded position into a release position by means of a drive device 32 (see FIG. 4).

For this purpose, the hook body 18 in the embodiment example shown in FIG. 4 is pivoted counterclockwise beyond the unloaded position into the release position. This results in the engagement sections 24a-b disengaging from the respective coupling recesses 22, sliding along the abutment surface 26 and being released outwards through a lead-out groove 36 in each case.

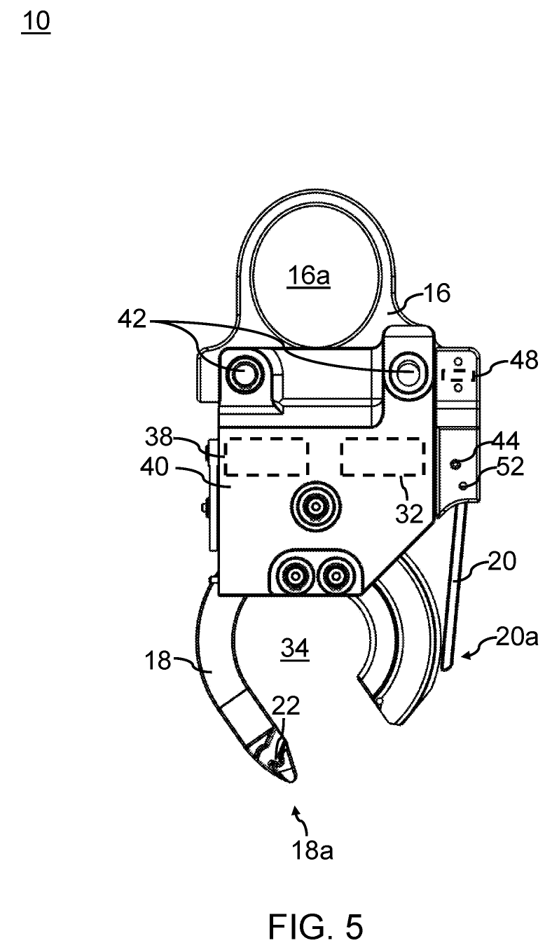

By means of the drive device 32, the hook body 18 is furthermore pivotable from the unloaded position into an open position in which the suspension opening 34 is open and cannot be closed by the safety lever 20 (see FIG. 5).

The load suspension device 10 has a sensor device 44 by means of which various lever positions of the safety lever 20 are detectable. The sensor device 44 can, for example, be designed as a potentiometer acting between the safety lever 20 and the base body 16.

By means of the sensor device 44, it is possible to detect when the safety lever 20 is in a first lever position, in a second lever position, in a third lever position or in a fourth lever position.

In the first lever position, the safety lever 20 abuts against the hook body 18 (e.g. against the abutment surface 26) (see FIG. 1).

In the second lever position, the safety lever 20 is coupled to the hook body 18 (see FIG. 2).

In the third lever position, the safety lever 20 is pivoted away from the hook body 18, which is in the unloaded position (see FIG. 3).

In the fourth lever position, the safety lever 20 is pivoted away from the hook body 18 located in the open position (see FIG. 5).

The load suspension device 10 comprises a control device configured to block pivoting of the hook body 18 from the open position to the unloaded position by means of the drive device 32 when it is detected by means of the sensor device 44 that the safety lever 20 is not in the fourth lever position. This can prevent unintentional closing of the load suspension device 10.

Furthermore, it is conceivable that a pivoting of the hook body 18 from the open position to the unloaded position can only be performed by a two-button operation (e.g. on a transmitter unit as disclosed herein).

Preferably, the drive device 32 is remotely controllable via a remote control. For this purpose, the load suspension device 10 may comprise a control device and a receiver unit, wherein the receiver unit is configured for wireless communication with a transmitter unit, such as the remote control. The control device is configured to control the drive device 32 in response to communication signals from the transmitter unit.

For example, it is conceivable that the hook body 18 is pivotable between the open position, the unloaded position and the release position (and vice versa) by means of the remote control in such a manner. In particular, it is conceivable that the hook body 18 can be automatically released (e.g. by automatically moving the hook body 18 from the unloaded position to the open position).

In order to detect whether the hook body 18 is in the loaded position or in the unloaded position, the load suspension device 10 optionally comprises at least one further sensor device 48.

In order to prevent the hook body 18 from moving under load application, a spring device 42 can be provided, which is arranged to act between the displacement body 40 and the base body 16. During lifting, the spring device 42 is acted upon (e.g. compressed) by the load 14 attached to the hook body 18 such that the hook body 18 is displaced from the unloaded position into the loaded position. In the unloaded position, an electrical power supply to the drive device 32 is enabled and in the loaded position, the electrical power supply to the drive device 32 is blocked in order to prevent the hook body 18 from pivoting by means of the drive device 32 under the load application.

To transmit drive power between the drive device 32 and the hook body 18, the load suspension device 10 comprises a worm gear 38.

The drive device 32 is attached to the displacement body 40 and, as also the hook body 18, is displaced together with the displacement body upon load application.

Both the drive device 32 and the worm gear 38 are arranged in a housing of the load suspension device 10 and are therefore only symbolized by semicolon lines in the figures.

In this embodiment example, the worm gear 38 comprises a worm shaft supported on the displacement body 40 and a worm wheel meshing with the worm shaft. The worm wheel is connected (e.g. screwed) to the hook body 18.

The worm gear 38 comprises a self-locking effect which counteracts a pivoting of the hook body 18 from the loaded position to the open position caused by the load application K.

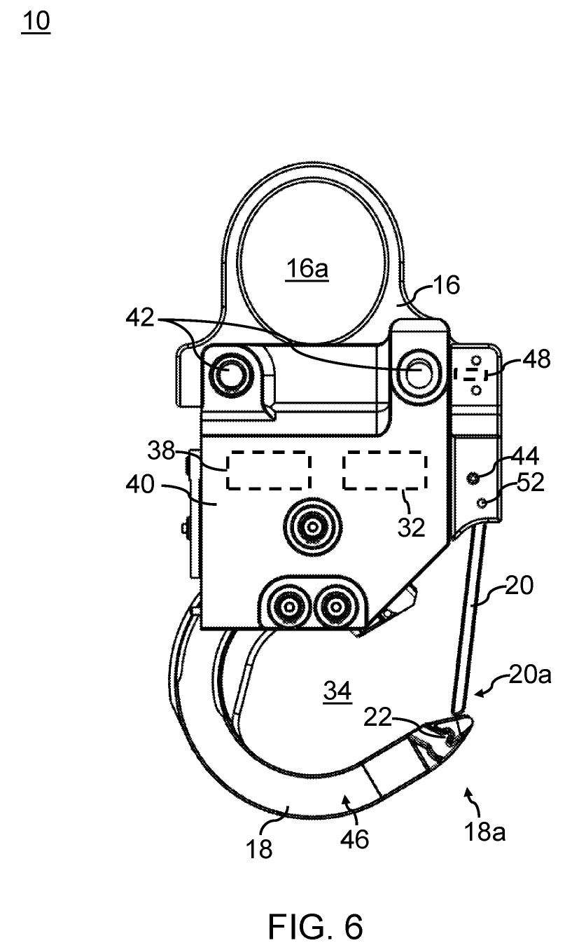

FIG. 6 shows a schematic illustration of an embodiment example of the load suspension device 10.

The hook body 18 has been moved from the open position (FIG. 5) towards the unloaded position by means of the drive device 32. Before the hook body 18 reaches the unloaded position (e.g. FIG. 1), the free end 18a of the hook body 18 contacts the free end 20a of the safety lever 20. In this embodiment example, the free end 18a of the hook body 18 is tapered such that the free end 20a of the safety lever 20 slides along the hook body 18, which is pivoted by means of the drive device 32, into the unloaded position. The positioning of the safety lever 20 can be supported by the fact that the safety lever 20 is first pressed against an outer contour of the hook body 18 by the spring 52 already described and finally against the abutment surface 26 when the hook body 18 has reached the unloaded position.

FIG. 7 shows a lifting device 100 according to an embodiment example.

As an example, the lifting device 100 can be designed as a crane.

A carrying means 12 (e.g. a carrying rope) of the lifting device 100 is attached to the base body 16 of the load suspension device 10 (e.g. to the eyelet 16a already described).

Suspended from the hook body 18 of the load suspension device 10, here as an example, is a load-side carrying means 50, to which a load 14 is attached.

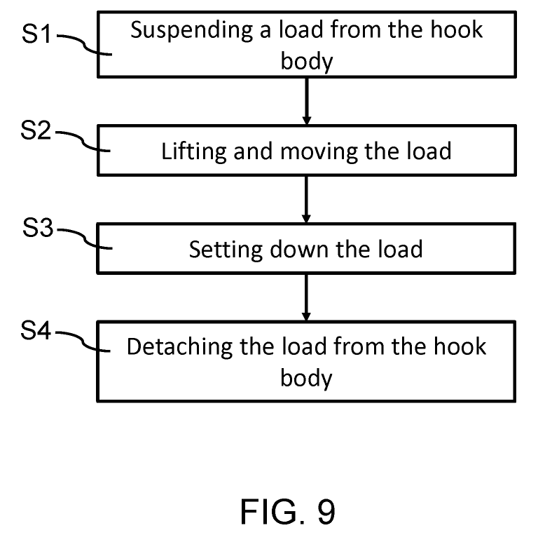

FIG. 9 shows a schematic detailed illustration of a safety lever 20 in a front view.

In the embodiment example shown, the safety lever 20 comprises a T-shaped through recess 30 formed as an undercut.

At its free end 20a, two projections facing each other form the engagement sections 24a-b.

The through recess 30 is dimensioned such that the free end 18a of the hook body 18 can be guided through the through recess 30.

The projections can then engage in the manner already described, for example in the coupling recesses 22 provided on longitudinal outer sides 46 of the hook body 18, when the hook body 18 is displaced into the loaded position by the load application K.

FIG. 9 shows a schematic flow diagram of a method for lifting and/or moving a load 14.

In a simple embodiment example, the method may comprise using the load suspension device 10 as disclosed herein.

By way of example only, the method may further comprise providing the load suspension device 10. The load suspension device 10 is attached to a carrying means 12 of a lifting device 100 via an eyelet 16a of the base body 16. The load suspension device 10 is exemplarily in the unloaded position.

The method may comprise hooking a load-side carrying means 50 into the suspension opening 34. For this purpose, the safety lever 20 can be pivoted inwards from the abutment surface 26.

The method may further comprise lifting the load 14 by means of the lifting device 100, whereby the hook body 18 is moved from the unloaded position to the loaded position. This allows the engagement sections 24a-b to engage in the respective coupling recess 22, guiding the pivoting movement of the safety lever 20 to be blocked for as long as the hook body 18 is loaded with the load 14.

The load 14 can now be moved to its destination by means of the lifting device 100.

Setting down the load 14 guides the hook body 18 to be pressed into the unloaded position by the spring device 42. This releases the pivoting movement of the safety lever 20.

For unrigging the load 14, the safety lever 20 can be pivoted inwards again and the load-side support means 50 can be unhooked from the suspension opening 34.

The invention is not limited to the embodiments described above. Rather, the invention also includes variants and modifications which also make use of the inventive concept and therefore fall within the scope of protection. In particular, the invention also claims protection for the subject matter and the features of the subclaims independently of the claims referred to in each case and, in particular, also without the features of the main claim. The invention thus comprises various aspects of the invention which enjoy protection independently of each other.

### LIST OF REFERENCE SIGNS

10 Load suspension device
12 Carrying means
14 Load
16 Base body
16a Eyelet
18 Hook body
18a Free end of hook body
20 Safety lever
20a Free end of the safety lever
22 Coupling recess
24a-b Engagement section
26 Abutment surface
28 Insertion groove
30 Through recess
32 Drive device
34 Suspension opening
36 Lead-out groove
38 Worm gear
40 Displacement body
42 Spring device
44 Sensor device
46 Longitudinal outer side of the hook body
48 Further sensor devices
50 Load-side carrying means
52 Spring
100 Lifting device
K Load application

What is claimed is:

1. A load suspension device, wherein the load suspension device is configured for attaching to a carrying means and for suspending a load, comprising
a base body;
a curved hook body, wherein the load is suspendable from the curved hook body, and
a safety lever, wherein the safety lever is pivotably connected to the base body, wherein
the curved hook body is adjustable relative to the base body between a unloaded position and a loaded position in dependence on a load application by the load, and
the safety lever is configured to perform a pivoting movement relative to the curved hook body in the unloaded position for suspending the load from the curved hook body,
characterized in that
the safety lever is configured to be coupled to the curved hook body in the loaded position such that the pivoting movement relative to the curved hook body is blocked.

2. The load suspension device according to claim 1, wherein the curved hook body comprises at least one coupling recess, wherein at least one engagement section of the safety lever engages in the at least one coupling recess in the loaded position in order to connect the safety lever to the curved hook body in a form-fitting manner.

3. The load suspension device according to claim 2, wherein the curved hook body comprises at least one abutment surface which is arranged adjacent to the at least one coupling recess, wherein the at least one engagement section abuts against the at least one abutment surface in the unloaded position and engages from the at least one abutment surface into the at least one coupling recess by an adjustment of the curved hook body from the unloaded position into the loaded position.

4. The load suspension device according to claim 3, wherein the curved hook body comprises at least one insertion groove, through which the at least one engagement section is guidable to the at least one coupling recess and/or to the at least one abutment surface.

5. The load suspension device according to claim 2, wherein the safety lever comprises a T-shaped and/or undercut through recess through which a free end of the curved hook body is guidable.

6. The load suspension device according to claim 2, wherein the safety lever comprises at least one projection at its free end, which forms the at least one engagement section, wherein the at least one projection is engaged in the at least one coupling recess in the loaded position.

7. The load suspension device according to claim 1, comprising a drive device, by use of which the curved hook body is pivotable relative to the base body between the unloaded position and an open position, wherein the curved hook body forms a suspension opening, via which the load is suspendable from the curved hook body and which is open in the open position and is closable in the unloaded position by use of the safety lever.

8. The load suspension device according to claim 7, wherein the drive device is configured to pivot the curved hook body from the unloaded position into a release position, in which the safety lever is released from the curved hook body by sliding over at least one abutment surface and through a lead-out groove of the curved hook body.

9. The load suspension device according to claim 7, comprising a worm gear which drivingly connects the drive device and the curved hook body.

10. The load suspension device according to claim 7, comprising:
a displacement body to which the drive device is attached, wherein the displacement body is movable relative to the base body; and
a spring device which is arranged to act between the displacement body and the base body, wherein the spring device is applied during lifting by the load suspended from the curved hook body such that the curved hook body is displaced from the unloaded position into the loaded position, wherein an electrical power supply to the drive device is enabled in the unloaded position and the electrical power supply to the drive device is blocked in the loaded position in order to prevent the curved hook body from pivoting by use of the drive device under the load application.

11. The load suspension device according to claim 1, comprising a sensor device, by use of which it can be detected when the safety lever is in at least one of the following positions:
a first lever position, in which the safety lever abuts against the curved hook body;
a second lever position, in which the safety lever is coupled to the curved hook body;
a third lever position, in which the safety lever is pivoted away from the curved hook body being in the unloaded position; and
a fourth lever position, in which the safety lever is pivoted away from the curved hook body being in an open position.

12. The load suspension device according to claim 11, comprising a control device which is configured to block a pivoting of the curved hook body from the open position into the unloaded position by use of a drive device when it is detected by use of the sensor device that the safety lever is not in the fourth lever position.

13. The load suspension device according to claim 2, wherein the at least one coupling recess comprises two coupling recesses which are arranged on opposite longitudinal outer sides of the curved hook body and the at least one engagement section comprises two engagement sections which, in the loaded position, engage in the two coupling recesses in order to connect the safety lever to the curved hook body in a form-fitting manner.

14. The load suspension device according to claim 2, comprising at least one of the following features:
the safety lever is coupled to the curved hook body in the loaded position of the curved hook body such that a force caused by the load application is at least partially transmittable from the curved hook body via the safety lever into the base body;
the curved hook body is configured to release the safety lever by a disengaging from the at least one coupling recess upon an adjustment from the loaded position to the unloaded position;
the at least one coupling recess is arranged at a free end and/or at least one longitudinal outer side of the curved hook body;
the pivoting movement of the safety lever in the unloaded position of the curved hook body is blocked by at least one abutment surface in a first pivoting direction and enabled in an opposite second pivoting direction;
the safety lever engages in the at least one coupling recess in the loaded position for coupling and does not engage in the at least one coupling recess in the unloaded position for release; and
the load suspension device comprises at least one further sensor device by use of which it is detectable when the curved hook body is in the loaded position, when the curved hook body is in the unloaded position, when the curved hook body is in an open position and/or when the curved hook body is in a release position.

15. The load suspension device according to claim 1, wherein the load suspension device is a crane hook.

16. The load suspension device according to claim 8, wherein in the release position at least one engagement section is released from the curved hook body by sliding over the at least one abutment surface and through a lead-out groove of the curved hook body.

17. The load suspension device according to claim 11, wherein in the first lever position the safety lever abuts against at least one abutment surface of the curved hook body.

18. A lifting device, comprising:
a carrying means; and
a load suspension device according to claim 1, which is attached to the carrying means.

19. The lifting device according to claim 18, wherein the lifting device is a crane.

20. The lifting device according to claim 18, wherein the carrying means is a carrying rope.

21. A method for lifting and/or moving a load, wherein the load suspension device according to claim 1 is used.
